(19) United States
(12) Patent Application Publication
(10) Pub. No.: US 2015/0365649 A1
(43) Pub. Date: Dec. 17, 2015

(54) Method and Apparatus of Disparity Vector Derivation in 3D Video Coding

(71) Applicant: MEDIATEK INC., Taiwan (CN)

(72) Inventors: Yi-Wen CHEN, Taichung City (TW); Na ZHANG, Shangqiu, Henan Province (CN); Jian-Liang LIN, Su'ao Township, Yilan County (TW)

(73) Assignee: Mediatek Inc.

(21) Appl. No.: 14/763,219

(22) PCT Filed: Jan. 10, 2014
(86) PCT No.: PCT/CN2014/070463

§ 371 Date: Jul. 24, 2015

(30) Foreign Application Priority Data
Apr. 9, 2013 (CN) PCT/CN2013/073971

(51) Int. Cl. H04N 13/00; H04N 19/51

(52) U.S. Cl. CPC H04N 13/0048; H04N 19/51

(57) ABSTRACT

A method and apparatus for three-dimensional video encoding or decoding using an improved refined DV derivation process are disclosed. Embodiments according to the present invention first determine a derived DV (disparity vector) from temporal, spatial, or inter-view neighboring blocks, or any combination thereof of the current block in a dependent view. A refined DV is then determined based on the derived DV when the derived DV exists and is valid. When the derived DV does not exist or is not valid, the refined DV is determined based on a zero DV or a default DV. The derived DV, the zero DV, or the default DV is used respectively to locate a corresponding block in a coded view, and a corresponding depth block in the coded view is used to determine the refined DV.

### CROSS REFERENCE TO RELATED APPLICATIONS

The present invention is a National Phase Application of PCT Application No. PCT/CN2014/070463, filed on Jan. 10, 2014, which claims priority to PCT Patent Application, Serial No. PCT/CN2013/073971, filed on Apr. 9, 2013, entitled “Default Vector for Disparity Vector Derivation for 3D Video Coding”. The PCT Patent Applications are hereby incorporated by reference in their entireties.

### TECHNICAL FIELD

The present invention relates to three-dimensional video coding. In particular, the present invention relates to disparity vector derivation for three-dimensional (3D) coding tools in 3D video coding.

### BACKGROUND

Three-dimensional (3D) television has been a technology trend in recent years that intends to bring viewers sensational viewing experience. Various technologies have been developed to enable 3D viewing. Among them, the multi-view video is a key technology for 3DTV application among others. The traditional video is a two-dimensional (2D) medium that only provides viewers a single view of a scene from the perspective of the camera. However, the multi-view video is capable of offering arbitrary viewpoints of dynamic scenes and provides viewers the sensation of realism.

The multi-view video is typically created by capturing a scene using multiple cameras simultaneously, where the multiple cameras are properly located so that each camera captures the scene from one viewpoint. Accordingly, the multiple cameras will capture multiple video sequences corresponding to multiple views. In order to provide more views, more cameras have been used to generate multi-view video with a large number of video sequences associated with the views. Accordingly, the multi-view video will require a large storage space to store and/or a high bandwidth to transmit. Therefore, multi-view video coding techniques have been developed in the field to reduce the required storage space or the transmission bandwidth.

A straightforward approach may be to simply apply conventional video coding techniques to each single-view video sequence independently and disregard any correlation among different views. Such coding system would be very inefficient. In order to improve efficiency of multi-view video coding, typical multi-view video coding exploits inter-view redundancy. Therefore, most 3D Video Coding (3DVC) systems take into account of the correlation of video data associated with multiple views and depth maps. The standard development body, the Joint Video Team of the ITU-T Video Coding Experts Group (VCEG) and the ISO/IEC Moving Picture Experts Group (MPEG), extended H.264/MPEG-4 AVC to multi-view video coding (MVC) for stereo and multi-view videos.

The MVC adopts both temporal and spatial predictions to improve compression efficiency. During the development of MVC, some macroblock-level coding tools are proposed, including illumination compensation, adaptive reference filtering, motion skip mode, and view synthesis prediction. These coding tools are proposed to exploit the redundancy between multiple views. Illumination compensation is intended for compensating the illumination variations between different views. Adaptive reference filtering is intended to reduce the variations due to focus mismatch among the cameras. Motion skip mode allows the motion vectors in the current view to be inferred from the other views. View synthesis prediction is applied to predict a picture of the current view from other views.

In the reference software for HEVC based 3D video coding (3D-HTM), inter-view candidate is added as a motion vector (MV) or disparity vector (DV) candidate for Inter, Merge and Skip mode in order to re-use previously coded motion information of adjacent views. In 3D-HTM, the basic unit for compression, termed as coding unit (CU), is a 2N×2N square block. Each CU can be recursively split into four smaller CUs until a predefined minimum size is reached. Each CU contains one or more prediction units (PUs).

To share the previously coded texture information of adjacent views, a technique known as Disparity-Compensated Prediction (DCP) has been included in 3D-HTM as an alternative coding tool to motion-compensated prediction (MCP). MCP refers to an inter-picture prediction that uses previously coded pictures of the same view, while DCP refers to an inter-picture prediction that uses previously coded pictures of other views in the same access unit. FIG. 1 illustrates an example of 3D video coding system incorporating MCP and DCP. The vector (110) used for DCP is termed as disparity vector (DV), which is analog to the motion vector (MV) used in MCP. FIG. 1 illustrates three MVs (120, 130 and 140) associated with MCP. Moreover, the DV of a DCP block can also be predicted by the disparity vector predictor (DVP) candidate derived from neighboring blocks or the temporal collocated blocks that also use inter-view reference pictures. In 3D-HTM version 3.1, when deriving an inter-view Merge candidate for Merge/Skip modes, if the motion information of corresponding block is not available or not valid, the inter-view Merge candidate is replaced by a DV.

Inter-view residual prediction is another coding tool used in 3D-HTM. To share the previously coded residual information of adjacent views, the residual signal of the current prediction block (i.e., PU) can be predicted by the residual signals of the corresponding blocks in the inter-view pictures as shown in FIG. 2. The corresponding blocks can be located by respective DVs. The video pictures and depth maps corresponding to a particular camera position are indicated by a view identifier (i.e., V0, V1 and V2 in FIG. 2). All video pictures and depth maps that belong to the same camera position are associated with the same viewId (i.e., view identifier). The view identifiers are used for specifying the coding order within the access units and detecting missing views in error-prone environments. An access unit includes all video pictures and depth maps corresponding to the same time instant. Inside an access unit, the video picture and, when present, the associated depth map having viewId equal to 0 are coded first, followed by the video picture and depth map having viewId equal to 1, etc. The view with viewId equal to 0 (i.e., V0 in FIG. 2) is also referred to as the base view or the independent view. The base view video pictures can be coded using a conventional HEVC video coder without dependence on other views.

As can be seen in FIG. 2, for the current block, motion vector predictor (MVP)/disparity vector predictor (DVP) can be derived from the inter-view blocks in the inter-view pictures. In the following, inter-view blocks in inter-view picture may be abbreviated as inter-view blocks. The derived candidate is termed as inter-view candidates, which can be inter-view MVPs or DVPs. The coding tools that codes the motion information of a current block (e.g., a current prediction unit, PU) based on previously coded motion information in other views is termed as inter-view motion parameter prediction. Furthermore, a corresponding block in a neighboring view is termed as an inter-view block and the inter-view block is located using the disparity vector derived from the depth information of current block in current picture.

View synthesis prediction (VSP) is a technique to remove interview redundancies among video signal from different viewpoints, in which synthetic signal is used as references to predict a current picture. In 3D-HEVC test model, there exists a process to derive a disparity vector predictor. The derived disparity vector is then used to fetch a depth block in the depth image of the reference view. The fetched depth block would have the same size of the current prediction unit (PU), and it will then be used to do backward warping for the current PU. In addition, the warping operation may be performed at a sub-PU level precision, like 8×4 or 4×8 blocks. A maximum depth value is picked for a sub-PU block and used for warping all the pixels in the sub-PU block. The VSP technique is applied for texture picture coding. In current implementation, VSP is added as a new merging candidate to signal the use of VSP prediction. In such a way, a VSP block may be a skipped block without any residual, or a merge block with residual information coded.

The example shown in FIG. 2 corresponds to a view coding order from V0 (i.e., base view) to V1, and followed by V2. The current block in the current picture being coded is in V2. According to HTM3.1, all the MVs of reference blocks in the previously coded views can be considered as an inter-view candidate even if the inter-view pictures are not in the reference picture list of current picture. In FIG. 2, frames 210, 220 and 230 correspond to a video picture or a depth map from views V0, V1 and V2 at time t1 respectively. Block 232 is the current block in the current view, and blocks 212 and 222 are the current blocks in V0 and V1 respectively. For current block 212 in V0, a disparity vector (216) is used to locate the inter-view collocated block (214). Similarly, for current block 222 in V1, a disparity vector (226) is used to locate the inter-view collocated block (224). According to HTM-3.1, the motion vectors or disparity vectors associated with inter-view collocated blocks from any coded views can be included in the inter-view candidates. Therefore, the number of inter-view candidates can be rather large, which will require more processing time and large storage space. It is desirable to develop a method to reduce the processing time and or the storage requirement without causing noticeable impact on the system performance in terms of BD-rate or other performance measurement.

In 3DV-HTM version 3.1, a disparity vector can be used as a DVP candidate for Inter mode or as a Merge candidate for Merge/Skip mode. A derived disparity vector can also be used as an offset vector for inter-view motion prediction and inter-view residual prediction. When used as an offset vector, the DV is derived from spatial and temporal neighboring blocks as shown in FIGS. 3A and 3B. Multiple spatial and temporal neighboring blocks are determined and DV availability of the spatial and temporal neighboring blocks is checked according to a pre-determined order. This coding tool for DV derivation based on neighboring (spatial and temporal) blocks is termed as Neighboring Block DV (NBDV). As shown in FIG. 3A, the spatial neighboring block set includes the location diagonally across from the lower-left corner of the current block (i.e., A0), the location next to the left-bottom side of the current block (i.e., A1), the location diagonally across from the upper-left corner of the current block (i.e., B2), the location diagonally across from the upper-right corner of the current block (i.e., B0), and the location next to the top-right side of the current block (i.e., B1). As shown in FIG. 3B, the temporal neighboring block set includes the location at the center of the current block (i.e., B_{CTR}) and the location diagonally across from the lower-right corner of the current block (i.e., RB) in a temporal reference picture. Instead of the center location, other locations (e.g., a lower-right block) within the current block in the temporal reference picture may also be used. In other words, any block collocated with the current block can be included in the temporal block set. Once a block is identified as having a DV, the checking process will be terminated. An exemplary search order for the spatial neighboring blocks in FIG. 3A is (A1, B1, B0, A0, B2). An exemplary search order for the temporal neighboring blocks for the temporal neighboring blocks in FIG. 3B is (BR, B_{CTR}). The spatial and temporal neighboring blocks are the same as the spatial and temporal neighboring blocks of Inter mode (AMVP) and Merge modes in HEVC.

If a DCP coded block is not found in the neighboring block set (i.e., spatial and temporal neighboring blocks as shown in FIGS. 3A and 3B), the disparity information can be obtained from another coding tool (DV-MCP). In this case, when a spatial neighboring block is MCP coded block and its motion is predicted by the inter-view motion prediction, as shown in FIG. 4, the disparity vector used for the inter-view motion prediction represents a motion correspondence between the current and the inter-view reference picture. This type of motion vector is referred to as inter-view predicted motion vector and the blocks are referred to as DV-MCP blocks. FIG. 4 illustrates an example of a DV-MCP block, where the motion information of the DV-MCP block (410) is predicted from a corresponding block (420) in the inter-view reference picture. The location of the corresponding block (420) is specified by a disparity vector (430). The disparity vector used in the DV-MCP block represents a motion correspondence between the current and inter-view reference picture. The motion information (422) of the corresponding block (420) is used to predict motion information (412) of the current block (410) in the current view.

To indicate whether a MCP block is DV-MCP coded and to store the disparity vector for the inter-view motion parameters prediction, two variables are used to represent the motion vector information for each block:

dvMcpFlag, and

dvMcpDisparity.

When dvMcpFlag is equal to 1, the dvMcpDisparity is set to indicate that the disparity vector is used for the inter-view motion parameter prediction. In the construction process for the Inter mode (AMVP) and Merge candidate list, the dvMcpFlag of the candidate is set to 1 if the candidate is generated by inter-view motion parameter prediction and is set to 0 otherwise. The disparity vectors from DV-MCP blocks are used in following order: A0, A1, B0, B1, B2, Co1 (i.e., Collocated block, B_{CTR} or RB).

A method to enhance the NBDV by extracting a more accurate disparity vector (referred to as a refined DV in this disclosure) from the depth map is utilized in current 3D-HEVC. A depth block from coded depth map in the same access unit is first retrieved and used as a virtual depth of the current block. This coding tool for DV derivation is termed as Depth-oriented NBDV (DoNBDV). While coding the texture in view 1 and view 2 with the common test condition, the depth map in view 0 is already available. Therefore, the coding of texture in view 1 and view 2 can be benefited from the depth map in view 0. An estimated disparity vector can be extracted from the virtual depth shown in FIG. 5. The overall flow is as following:

1. Use an estimated disparity vector, which is the NBDV in current 3D-HTM, to locate the corresponding block in the coded texture view 2. Use the collocated depth in the coded view for current block (coding unit) as virtual depth.

3. Extract a disparity vector (i.e., a refined DV) for inter-view motion prediction from the maximum value in the virtual depth retrieved in the previous step.

In the example illustrated in FIG. 5, the coded depth map in view 0 is used to derive the DV for the texture frame in view 1 to be coded. A corresponding depth block (530) in the coded D0 is retrieved for the current block (CB, 510) according to the estimated disparity vector (540) and the location (520) of the current block of the coded depth map in view 0. The retrieved block (530) is then used as the virtual depth block (530′) for the current block to derive the DV. The maximum value in the virtual depth block (530′) is used to extract a disparity vector for inter-view motion prediction.

In current 3D-AVC (3D video coding based on Advanced Video Coding (AVC)), the disparity vector (DV) is used for disparity compensated prediction (DCP), predicting a DV and indicating the inter-view corresponding block to derive an inter-view candidate.

In Inter mode, Direction-Separate Motion Vector Prediction (DS-MVP) is another coding tool used in 3D-AVC. The direction-separate motion vector prediction consists of the temporal and inter-view motion vector prediction. If the target reference picture is a temporal prediction picture, the temporal motion vectors of the adjacent blocks around the current block Cb, such as A, B, and C in FIG. 6A are employed in the derivation of the motion vector prediction. If a temporal motion vector is unavailable, an inter-view motion vector is used. The inter-view motion vector is derived from the corresponding block indicated by a DV converted from depth. The motion vector prediction is then derived as the median of the motion vectors of the adjacent blocks A, B, and C. Block D is used only when C is unavailable.

On the contrary, if the target reference picture is an inter-view prediction picture, the inter-view motion vectors of the neighboring blocks are employed for the inter-view prediction. If an inter-view motion vector is unavailable, a disparity vector which is derived from the maximum depth value of four corner depth samples within the associated depth block is used. The motion vector predictor is then derived as the median of the inter-view motion vector of the adjacent blocks A, B, and C.

When the target reference picture is an inter-view prediction picture, the inter-view motion vectors of the neighboring blocks are used to derive the inter-view motion vector predictor. In block 610 of FIG. 6B, inter-view motion vectors of the spatially neighboring blocks are derived based on the texture data of respective blocks. The depth map associated with the current block Cb is also provided in block 660. The availability of inter-view motion vector for blocks A, B and C is checked in block 620. If an inter-view motion vector is unavailable, the disparity vector for the current block is used to replace the unavailable inter-view motion vector as shown in block 630. The disparity vector is derived from the maximum depth value of the associated depth block as shown in block 670. The median of the inter-view motion vectors of blocks A, B and C is used as the inter-view motion vector predictor. The conventional MVP procedure, where a final MVP is derived based on the median of the motion vectors of the inter-view MVPs or temporal MVPs as shown in block 640. Motion vector coding based on the motion vector predictor is performed as shown in block 650.

Priority based MVP candidate derivation for Skip/Direct mode is another coding tool for 3D-AVC. In Skip/Direct mode, a MVP candidate is derived based on a predefined derivation order: inter-view candidate and the median of three spatial candidates derived from the neighboring blocks A, B, and C (D is used only when C is unavailable) as shown in FIG. 7.

Inter-view MV candidate derivation is also shown in FIG. 7. The central point (712) of the current block (710) in the dependent view and its disparity vector are used to find a corresponding point in the base view or reference view. After that, the MV of the block including the corresponding point in the base view is used as the inter-view candidate of the current block. The disparity vector can be derived from both the neighboring blocks (A, B and C/D) and the depth value of the central point. Specifically, if only one of the neighboring blocks has disparity vector (DV), the DV is used as the disparity. Otherwise, the DV is then derived as the median of the DVs (720) of the adjacent blocks A, B, and C. If a DV is unavailable, a DV converted from depth is then used instead. The derived DV is used to locate a corresponding block (740) in the reference picture (730).

As described above, DV derivation is critical in 3D video coding for both 3D-HEVC and 3D-AVC. It is desirable to improve the DV derivation process to achieve better compression efficiency or reduced computations.

### SUMMARY

A method and apparatus for three-dimensional video encoding or decoding using an improved refined DV (disparity vector) derivation process are disclosed. Embodiments according to the present invention determine a derived DV from one or more temporal neighboring blocks, one or more spatial neighboring blocks, one or more inter-view neighboring blocks, or any combination thereof of the current block in the dependent view. A refined DV is then determined based on the derived DV when the derived DV exists and is valid. When the derived DV does not exist or is not valid, the refined DV is determined based on a zero DV or a default DV. The derived DV, the zero DV, or the default DV is used respectively to locate a corresponding block in a coded view, and a corresponding depth block in the coded view is used to determine the refined DV. The default DV can be derived from coded texture or depth data in another view or from a previously coded picture in a same view. The default DV can also be implicitly derived at both encoder and decoder using previously coded inter-view information, wherein the inter-view information includes one or more of pixel values, one or more motion vectors, or one or more disparity vectors. Furthermore, the default DV can be explicitly incorporated in a sequence level (SPS), view level (VPS), picture level (PPS) or slice header of a code bitstream.

One aspect of the present invention addresses simplified derivation process of the derived DV. According to the conventional method, the derived DV is determined by checking the DV availability of disparity compensated prediction (DCP) coded block among the spatial and temporal neighboring blocks. If no DCP coded block is available, the derivation process of the derived DV further checks availability of Disparity Derivation from Motion Compensated Prediction (DV-MCP) coded block among the spatial neighboring blocks. In one embodiment of the present invention, the checking of the availability of disparity compensated prediction (DCP) coded block among the temporal neighboring blocks is skipped. In another embodiment, the derivation process for the derived DV is terminated without further checking availability of DV-MCP coded block among the spatial neighboring blocks when no derived DV is available or valid from the spatial and temporal neighboring blocks. In yet another embodiment, the checking of the availability of DCP coded block among the temporal neighboring blocks is performed for the temporal neighboring blocks from only one of two collocated pictures. In yet another embodiment, the checking of the availability of DCP coded block among the temporal neighboring blocks is performed for the temporal neighboring blocks from only one of two collocated pictures, and the derivation process of the derived DV is terminated without further checking availability of DV-MCP coded block among the spatial neighboring blocks when no derived DV is available or valid from the spatial and temporal neighboring blocks. Another aspect of the present invention address determination of said only one of two collocated pictures.

### BRIEF DESCRIPTION OF DRAWINGS

FIG. 1 illustrates an example of three-dimensional coding incorporating disparity-compensated prediction (DCP) as an alternative to motion-compensated prediction (MCP).

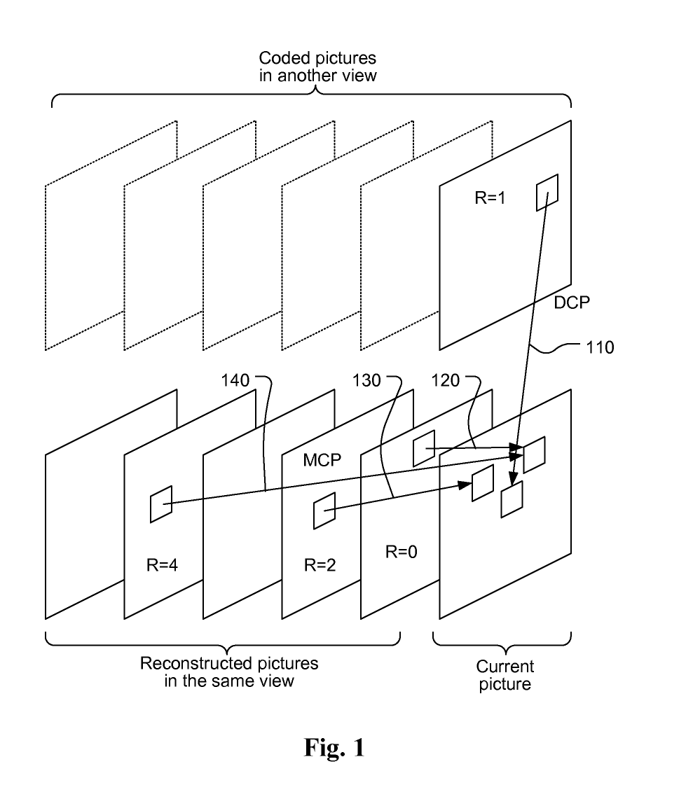

FIG. 2 illustrates an example of three-dimensional coding utilizing previously coded information or residual information from adjacent views in HTM-3.1.

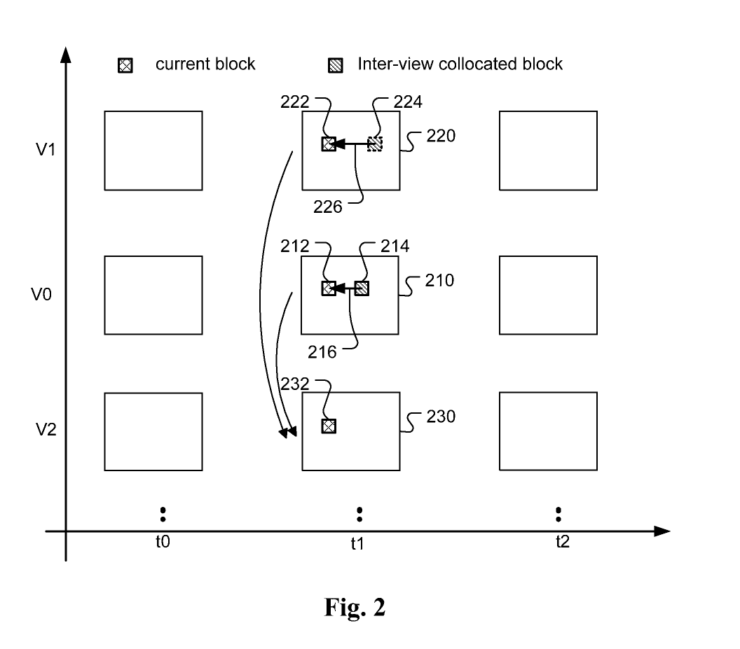

FIGS. 3A-3B illustrate respective spatial neighboring blocks and temporal neighboring blocks of a current block for deriving a disparity vector for the current block in HTM-3.1.

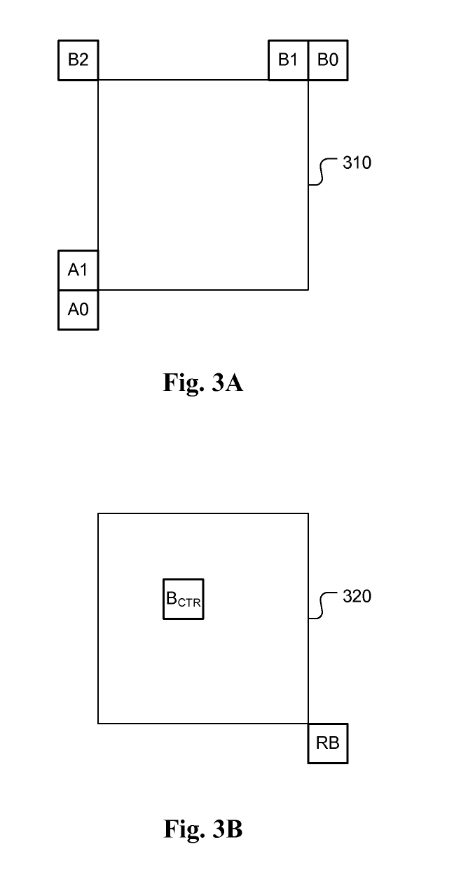

FIG. 4 illustrates an example of a disparity derivation from motion-compensated prediction (DV-MCP) block, where the location of the corresponding blocks is specified by a disparity vector.

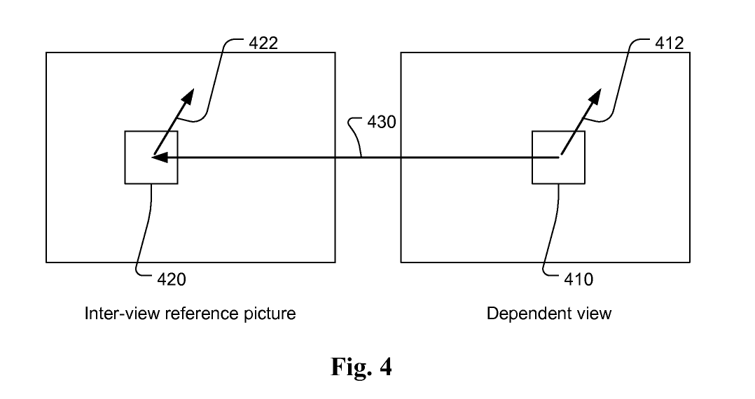

FIG. 5 illustrates an example of derivation of an estimated disparity vector based on the virtual depth of the block.

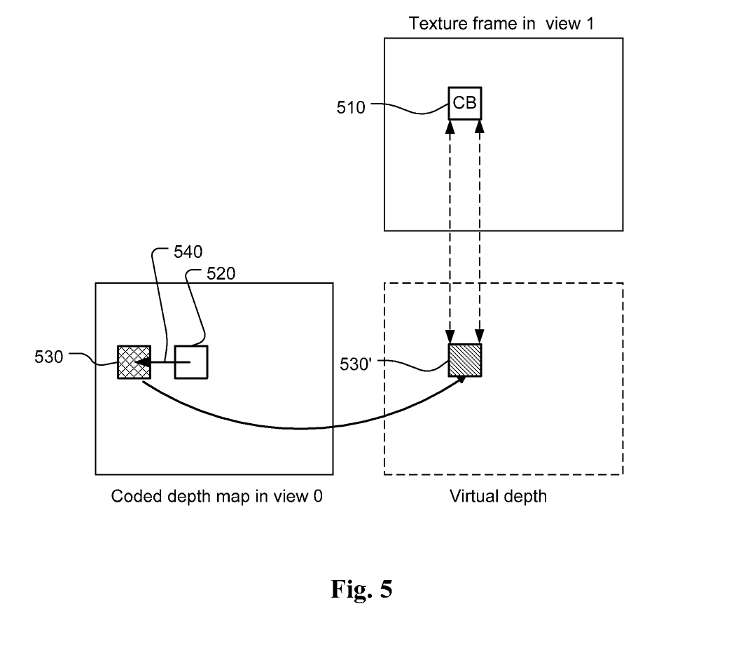

FIGS. 6A-6B illustrate an example of direction-separated motion vector prediction (DS-MVP) for Inter mode in 3D-AVC.

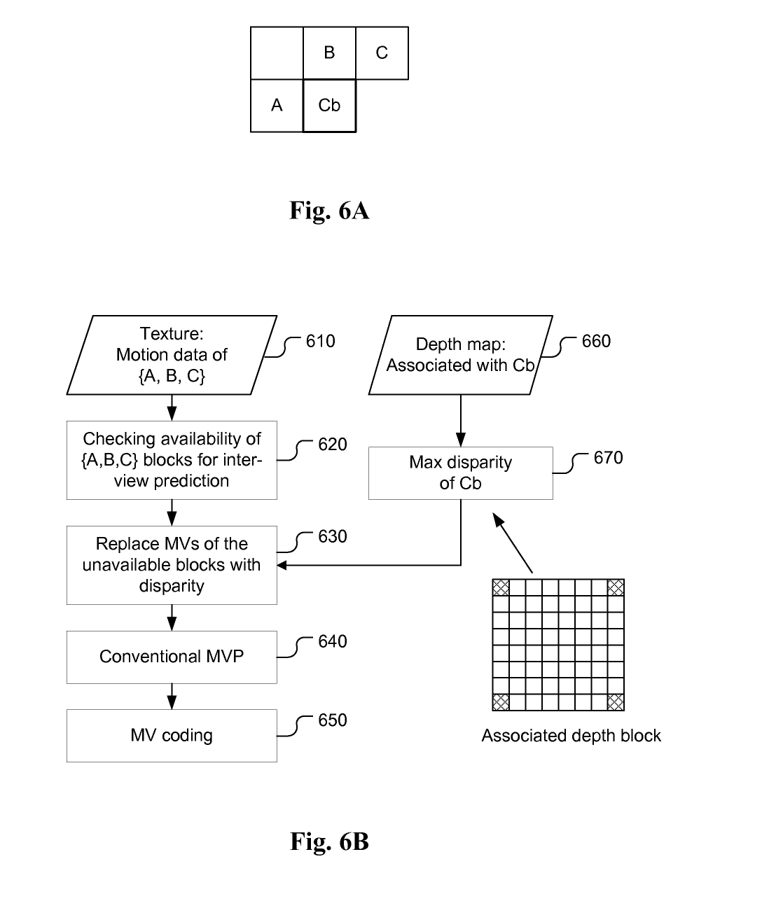

FIG. 7 illustrates an example of priority based MVP candidate derivation for Skip/Direct modes in 3D-AVC.

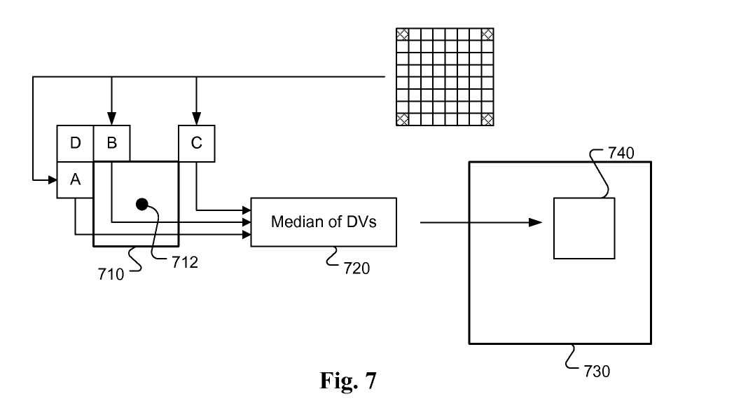

FIG. 8A illustrates an exemplary flowchart of refined DV derivation using NBVD and DoNBDV according to conventional HEVC-based 3D coding.

FIG. 8B illustrates an exemplary flowchart of refined DV derivation incorporating an embodiment of the present invention.

FIG. 9 illustrates an exemplary flowchart of an inter-view predictive coding system incorporating improved refined DV derivation according to an embodiment of the present invention.

### DETAILED DESCRIPTION

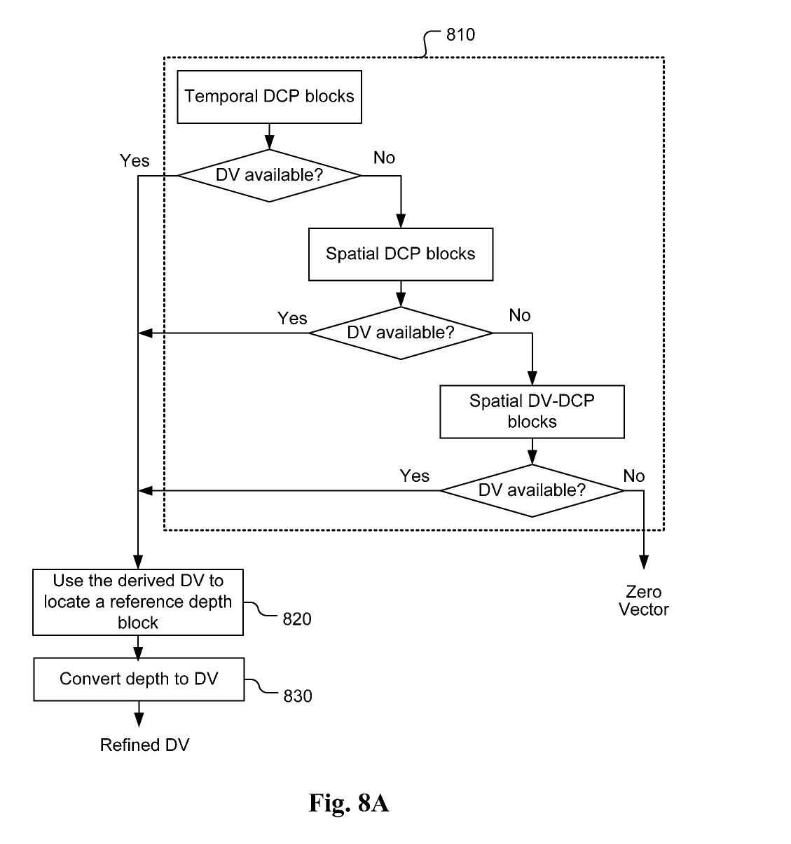

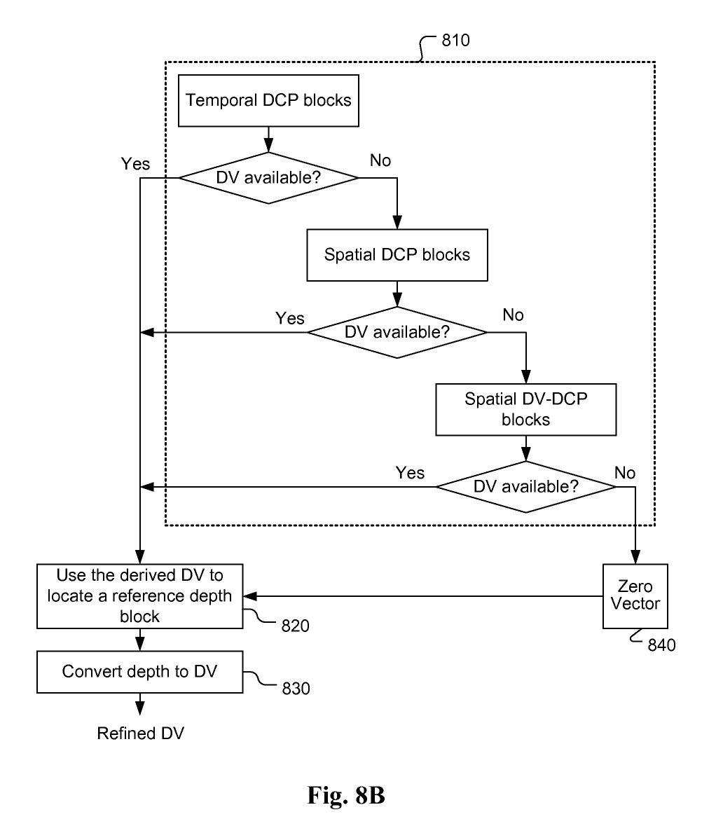

As described above, Disparity Vector (DV) is critical in 3D video coding for both 3D-HEVC and 3D-AVC. In the existing 3D-HEVC, a DV is first derived based on the NBDV process as shown in FIG. 8A. The NBDV process is indicated by the dashed box (810) in FIG. 8A. The derived DV is then used by the DoNBDV process to retrieve the virtual depth in the reference view (820) and to convert the depth to a DV (830) in order to derive a refined DV. When no derived DV is available from the NBDV process, the NBDV process will simply outputs a zero DV and the DoNBDV process will not be performed. Embodiments of the present invention use a zero vector or a default disparity vector to locate the reference depth block in the reference view to derive a refined DV when no derived DV is available or valid from spatial or temporal neighboring blocks. To be more specific, as shown in FIG. 8B, when no derived DV is available or valid using NBDV, a zero vector (840) or a default disparity vector is used as an input DV to DoNBDV to locate the reference depth block in the reference view in order to derive a refined DV.

The default DV can be derived from coded texture or depth data in another view or from a previously coded picture in a same view. The default DV may also be implicitly derived at both encoder and decoder using previously coded inter-view information. The inter-view information may include one or more of pixel values, one or more motion vectors, or one or more disparity vectors. Furthermore, the default DV can be explicitly incorporated in a sequence level (SPS), view level (VPS), picture level (PPS) or slice header of a code bitstream. The default DV can be a default global DV that can be derived and applied to a slice level, picture level or sequence level to compensate the offset between two views.

Furthermore, the NBDV process can be simplified according to the present invention. For example, the step of checking temporal DCP blocks can be skipped. Since a zero vector, a default DV or a default global DV can be used to derive the refined DV according to the present invention when the derived DV is not available or not valid, the step of checking temporal blocks to derive the derived DV can be skipped without causing significant impact on the performance. The use of temporal blocks implies the need of memory to store and bandwidth to access the temporal blocks. Accordingly, skipping the step of checking temporal blocks can save the memory requirement and/or memory access bandwidth.

Another simplification of the NBDV process is to only check temporal DCP blocks in one temporal collocated picture. When a zero vector, a default DV or a default global DV is used to derive the refined DV according to the present invention when the derived DV is not available or not valid, the number of collocated pictures for checking temporal DCP blocks can be reduced from two to one. The one of two collocated pictures can be set to the same as the collocated picture used by a temporal motion vector predictor (TMVP) for the current texture block. The one of two collocated pictures can also be explicitly signaled.

Yet another simplification of the NBDV process is to skip the step of checking spatial DV-MCP blocks. When a zero vector, a default DV or a default global DV is used to derive the refined DV according to the present invention when the derived DV is not available or not valid, the step of checking the spatial DV-MCP blocks to derive the derived DV can be skipped to save the memory access bandwidth.

Yet another simplification of the NBDV process is to skip the step of checking temporal DCP blocks in only one temporal collocated picture and to skip the step of checking spatial DV-MCP blocks. When a zero vector, a default DV or a default global DV is used to derive the refined DV according to the present invention when the derived DV is not available or not valid, the number of collocated pictures for checking temporal DCP blocks can be reduced from two to one and the step of checking the spatial DV-MCP blocks to derive the DV can also be skipped to save the memory access bandwidth.

The performance of a 3D/multi-view video coding system incorporating an embodiment of the present invention, where a zero vector is used by the DoNBDV process to derive a refined DV when no derived DV is available or valid from the NBDV process, is compared with the performance of a conventional system based on HTM-6.0 as shown in Table 1. The performance comparison is based on different sets of test data listed in the first column. The BD-rate differences are shown for texture pictures in view 1 (video 1) and view 2 (video 2). A negative value in the BD-rate implies that the present invention has a better performance. As shown in Table 1, the BD-rate for texture pictures in view 1 and view 2 incorporating an embodiment of the present invention exhibits a reduced BD-rate of 0.2% over the HTM-6.0. The second group of performance is the bitrate measure for texture video only (video/video bitrate), the total bitrate (texture bitrate and depth bitrate) for texture video (video/total bitrate) and the total bitrate for coded and synthesized video (Coded & synth./total bitrate). As shown in Table 1, the average performance in this group also shows slight improvement (0.1%) over the conventional HTM-6.0. The processing times (encoding time, decoding time and rendering time) are also compared. As shown in Table 1, the encoding time, decoding time and rendering time go up slightly (0.9 to 1.5%). Accordingly, in the above example, the system using a zero vector for DoNBDV when no derived DV is available from NBDV achieves slight performance improvement over the conventional HTM-6.0.

TABLE 1

| | | | | | coded & | | | |
|---|---|---|---|---|---|---|---|---|
| | | | video/Video | video/total | synth/total | Enc | Dec | Ren |
| | Video 1 | Video 2 | bitrate | bitrate | bitrate | time | time | time |
| Balloons | −0.2% | −0.1% | −0.1% | −0.1% | −0.1% | 101.2% | 99.5% | 101.1% |
| Kendo | 0.0% | 0.0% | 0.0% | 0.0% | 0.0% | 100.6% | 98.5% | 100.0% |
| Newspapercc | −0.4% | −0.2% | −0.1% | −0.1% | −0.1% | 100.7% | 104.4% | 103.6% |
| GhostTownFly | 0.2% | 0.0% | 0.0% | 0.0% | 0.0% | 101.4% | 99.5% | 104.2% |
| PoznanHall2 | −0.8% | −0.5% | −0.3% | −0.3% | −0.2% | 100.7% | 105.0% | 105.5% |
| PoznanStreet | 0.0% | 0.0% | 0.0% | 0.0% | 0.0% | 101.1% | 101.5% | 97.7% |
| UndoDancer | −0.1% | −0.3% | −0.1% | −0.1% | −0.2% | 100.6% | 98.3% | 98.1% |
| 1024 × 768 | −0.2% | −0.1% | −0.1% | 0.0% | −0.1% | 100.8% | 100.8% | 101.6% |
| 1920 × 1088 | −0.2% | −0.2% | −0.1% | −0.1% | −0.1% | 100.9% | 101.1% | 101.4% |
| average | −0.2% | −0.2% | −0.1% | −0.1% | −0.1% | 100.9% | 100.9% | 101.5% |

The performance of a 3D/multi-view video coding system incorporating an embodiment of the present invention, where a zero vector is used by the DoNBDV process to derive a refined DV and the NBDV is simplified by skipping the step of checking temporal DCP blocks, is compared with the performance of a conventional system based on HTM-6.0 as shown in Table 2. The BD-rate differences for texture pictures in view 1 (video 1) and view 2 (video 2) are very small (+0.1% and −0.1%). As shown in Table 2, the average performance in this group is the same as the conventional HTM-6.0. As shown in Table 2, the encoding time, decoding time and rendering time go up slightly (0.4 to 1.2%). Accordingly, in the above example, the system using the simplified NBDV skips the step of checking temporal DCP blocks and using a zero vector for DoNBDV when no derived DV is available from NBDV achieves about the same performance as the conventional HTM-6.0. However, the system incorporating an embodiment of the present invention uses less memory space and less memory access bandwidth.

TABLE 2

| | | | | | coded & | | | |
|---|---|---|---|---|---|---|---|---|
| | | | video/Video | video/total | synth/total | Enc | Dec | Ren |
| | Video 1 | Video 2 | bitrate | bitrate | bitrate | time | time | time |
| Balloons | 0.0% | 0.1% | 0.1% | 0.1% | 0.0% | 100.8% | 104.7% | 100.8% |
| Kendo | −0.2% | 0.1% | 0.0% | 0.0% | 0.0% | 100.5% | 98.6% | 103.5% |
| Newspapercc | 0.1% | 0.6% | 0.1% | 0.1% | 0.0% | 100.6% | 103.5% | 102.2% |
| GhostTownFly | 0.1% | 0.2% | 0.0% | 0.0% | 0.1% | 101.4% | 95.2% | 102.0% |
| PoznanHall2 | −0.5% | −0.6% | −0.2% | −0.2% | −0.1% | 101.3% | 96.3% | 103.8% |
| PoznanStreet | 0.4% | 0.4% | 0.1% | 0.1% | 0.1% | 100.9% | 105.7% | 99.9% |
| UndoDancer | −0.4% | −0.1% | −0.1% | −0.1% | −0.2% | 100.6% | 98.8% | 95.9% |
| 1024 × 768 | 0.0% | 0.3% | 0.1% | 0.1% | 0.0% | 100.7% | 102.3% | 102.2% |
| 1920 × 1088 | −0.1% | 0.0% | 0.0% | 0.0% | −0.1% | 101.0% | 99.0% | 100.4% |
| average | −0.1% | 0.1% | 0.0% | 0.0% | 0.0% | 100.9% | 100.4% | 101.2% |

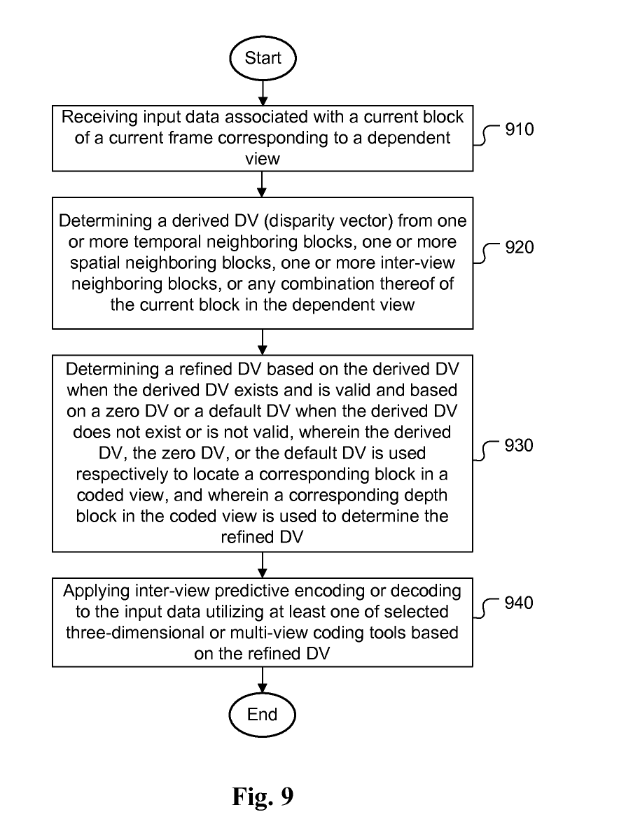

FIG. 9 illustrates an exemplary flowchart of a three-dimensional encoding or decoding system incorporating an improved refined DV derivation according to an embodiment of the present invention. The system receives input data associated with a current block of a current frame corresponding to a dependent view as shown in step 910. For encoding, the input data associated with the current block corresponds to original pixel data, depth data, residual data or other information associated with the current block (e.g., motion vector, disparity vector, motion vector difference, or disparity vector difference) to be coded. For decoding, the input data corresponds to coded block to be decoded. The input data may be retrieved from storage such as a computer memory, buffer (RAM or DRAM) or other media. The input data may also be received from a processor such as a controller, a central processing unit, a digital signal processor or electronic circuits that produce the input data. A derived DV (disparity vector) is determined from one or more temporal neighboring blocks, one or more spatial neighboring blocks, one or more inter-view neighboring blocks, or any combination thereof of the current block in the dependent view as shown in step 920. A refined DV is then determined based on the derived DV when the derived DV exists and is valid and based on a zero DV or a default DV when the derived DV does not exist or is not valid as shown in step 930, wherein the derived DV, the zero DV, or the default DV is used respectively to locate a corresponding block in a coded reference view, and wherein a corresponding depth block in the coded view is used to determine the refined DV. An embodiment of determining the refined DV is by converting the maximum disparity in the corresponding depth block, for example, the maximum disparity of four corner values of the corresponding depth block can be used to determine the refined DV. After the refine DV is determined, inter-view predictive encoding or decoding is applied to the input data utilizing at least one of selected three-dimensional or multi-view coding tools based on the refined DV as shown in step 940.

The flowcharts shown above are intended to illustrate examples of inter-view prediction using an improved refined DV process. A person skilled in the art may modify each step, re-arranges the steps, split a step, or combine steps to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for three-dimensional or multi-view video encoding or decoding, the method comprising:
receiving input data associated with a current block of a current frame corresponding to a dependent view;
determining a derived DV (disparity vector) from one or more temporal neighboring blocks, one or more spatial neighboring blocks, one or more inter-view neighboring blocks, or any combination thereof of the current block in the dependent view;
determining a refined DV based on the derived DV when the derived DV exists and is valid and based on a zero DV or a default DV when the derived DV does not exist or is not valid, wherein the derived DV, the zero DV, or the default DV is used respectively to locate a corresponding block in a coded view, and wherein a corresponding depth block in the coded view is used to determine the refined DV; and
applying inter-view predictive encoding or decoding to the input data utilizing at least one of selected three-dimensional or multi-view coding tools based on the refined DV.

2. The method of claim 1, wherein the default DV is derived from coded texture or depth data in another view or from a previously coded picture in a same view.

3. The method of claim 1, wherein the default DV is implicitly derived at both encoder and decoder using previously coded inter-view information, wherein the inter-view information includes one or more of pixel values, one or more motion vectors, or one or more disparity vectors.

4. The method of claim 1, wherein the default DV is explicitly incorporated in a sequence level (SPS), view level (VPS), picture level (PPS) or slice header of a code bitstream.

5. The method of claim 1, wherein said determining a derived DV checks availability of disparity compensated prediction (DCP) coded block among said one or more temporal neighboring blocks and said one or more spatial neighboring blocks, and when no DCP coded block is available, said determining a derived DV further checks availability of Disparity Derivation from Motion Compensated Prediction (DV-MCP) coded block among said one or more spatial neighboring blocks.

6. The method of claim 1, wherein said determining a derived DV checks availability of disparity compensated prediction (DCP) coded block among said one or more spatial neighboring blocks and skip checking the availability of the DCP coded block among said one or more temporal neighboring blocks, and when no DCP coded block is available, said determining a derived DV further checks availability of Disparity Derivation from Motion Compensated Prediction (DV-MCP) coded block among said one or more spatial neighboring.

7. The method of claim 1, wherein said determining a derived DV checks availability of disparity compensated prediction (DCP) coded block among said one or more temporal neighboring blocks and said one or more spatial neighboring blocks, and when no DCP coded block is available, said determining a derived DV is terminated without further checking availability of Disparity Derivation from Motion Compensated Prediction (DV-MCP) coded block among said one or more spatial neighboring blocks.

8. The method of claim 1, wherein said determining a derived DV checks availability of disparity compensated prediction (DCP) coded block among said one or more spatial neighboring blocks and said one or more temporal neighboring blocks from only one of two collocated pictures, and when no DCP coded block is available, said determining a derived DV is terminated without further checking availability of Disparity Derivation from Motion Compensated Prediction (DV-MCP) coded block among said one or more spatial neighboring blocks.

9. The method of claim 1, wherein said determining a derived DV checks availability of disparity compensated prediction (DCP) coded block among said one or more spatial neighboring blocks, and said one or more temporal neighboring blocks from only one of two collocated pictures, and when no DCP coded block is available, said determining a derived DV further checks availability of Disparity Derivation from Motion Compensated Prediction (DV-MCP) coded block among said one or more spatial neighboring blocks.

10. The method of claim 9, wherein said only one of two collocated pictures is set to the same as the collocated picture used by a temporal motion vector predictor (TMVP) for the current block.

11. The method of claim 9, wherein said only one of two collocated pictures is explicitly signaled.

12. The method of claim 1, wherein said selected three-dimensional or multi-view coding tools comprise one or more coding tool members from a group consisting of:
inter-view motion prediction in Inter mode/AMVP (Advance Motion Vector Prediction) and Skip/Merge mode, wherein the derived DV is used to indicate a first prediction block in a first reference view;
inter-view residual prediction, wherein the derived DV is used to indicate a second prediction block in a second reference view; and
disparity vector prediction using the derived DV for a DCP (Disparity-Compensated Prediction) block in the Inter mode/AMVP and the Skip/Merge mode.

13. An apparatus for three-dimensional or multi-view video encoding or decoding, the apparatus comprising one or more circuits, wherein said one or more circuits are configured to:
receive input data associated with a current block of a current frame corresponding to a dependent view;
determine a derived DV (disparity vector) from one or more temporal neighboring blocks, one or more spatial neighboring blocks, one or more inter-view neighboring blocks, or any combination thereof of the current block in the dependent view;
determine a refined DV based on the derived DV when the derived DV exists and is valid and based on a zero DV or a default DV when the derived DV does not exist or is not valid, wherein the derived DV, the zero DV, or the default DV is used respectively to locate a corresponding block in a coded view, and wherein a corresponding depth block in the coded view is used to determine the refined DV; and
apply inter-view predictive encoding or decoding to the input data utilizing at least one of selected three-dimensional or multi-view coding tools based on the refined DV.
